(19) United States
(12) Patent Application Publication
(10) Pub. No.: US 2007/0084330 A1
(43) Pub. Date: Apr. 19, 2007

(54) Tuning device for musical instruments and computer program for visualizing tuning status

(75) Inventor: Fukutaro Okuyama, Shizuoka-ken (JP)

Correspondence Address: HARNESS, DICKEY & PIERCE, P.L.C., P.O. BOX 828, BLOOMFIELD HILLS, MI, 48303, US

(73) Assignee: Yamaha Corporation, Hamamatsu-shi (JP)

(21) Appl. No.: 11/542,470

(22) Filed: Oct. 3, 2006

(30) Foreign Application Priority Data
Oct. 19, 2005 (JP) 2005-304285

(51) Int. Cl. G10G 7/02

(52) U.S. Cl. 84/454

(57) ABSTRACT

A tuning device assists a worker in a tuning work on a musical instrument such as an upright piano; the tuning device firstly converts a tone to a series of audio data, and analyzes a series of audio data so as to compare an actual pitch of the tone with a target pitch of the tone; when a pitch difference is found, the existence of pitch difference is visualized as a moving light pattern, and the direction of pitch difference is further visualized as a light pattern; the worker acknowledges the present tuning status of the musical instrument through the tuning device so that the worker accurately quickly tunes the musical instrument.

### FIELD OF THE INVENTION

This invention relates to a tuning device assisting a worker on a tuning work on musical instruments and a computer program used therein, more particularly, to a tuning device for visualizing difference between an actual pitch of a tone produced in the musical instrument and a target pitch of the tone and a computer program for visualizing the tuning status of the musical instrument.

### DESCRIPTION OF THE RELATED ART

The tuning device is designed to assist a worker in a tuning work on a musical instrument. While the user is producing tones in the musical instrument, the tuning device analyzes the sound waves for the pitch name, octave and difference from a target pitch, i.e., current tuning status of the musical instrument, and notifies the user of the current tuning status through visual images.

A typical example of the prior art tuning device is disclosed in Japanese Patent Publication No. Hei 3-42412. The prior art method disclosed in the Japanese Patent Publication is hereinafter briefly described. While the sound waves are being supplied from a musical instrument to the prior art tuning device, the tuning device converts the sound waves to an audio input signal, and produces a pulse train from the audio input signal. While the audio input signal is keeping the potential level over zero, the prior art tuning device also keeps the pulse at the high level. The pulse is decayed to the low level at the transit of the audio input signal to the negative. If the audio input signal keeps the potential level over zero for a long time, the corresponding pulse has a long pulse width. On the other hand, if the audio input signal keeps the potential level over zero for a short time, the pulse width of the corresponding pulse is made short. Thus, the irregular pulses form the pulse train with the variable pulse width.

The prior art tuning device introduces a delay time, which is equal to the time period from the first pulse rise to the next pulse rise, into the original pulse train, and produces the first delayed pulse train. A delay time, which is equal to the time period from the second pulse rise to the next pulse rise, is further introduced into the first delayed pulse train, and produces the second delayed pulse train. In this manner, the delay times, which are respectively equal to the pulse intervals of the original pulse train, are successively introduced into the delayed pulse trains.

Subsequently, the prior art tuning device checks the delayed pulse trains for the correlation with the original pulse train. If the total amount of delay time is equal to the major repetition period of the audio input signal which strongly relates to the pitch of the tone, the correlation with the original pulse train is found to be high. On the other hand, if the total amount of delay time is different from the major repetition period of the audio input signal, the delayed pulse train has a low value of the correlation with the original pulse train. Thus, the pitch of tone on the sound waves is determinable through the correlation analysis on the delayed pulse trains in spite of undesirable influences of short repetition periods on the audio input signal. The prior art tuning device disclosed in the Japanese Patent Publication is hereinafter referred to as “the first prior art tuning device”.

The prior art tuning devices inform the users of the difference between the target pitch and the actual pitch in various ways. A prior art tuning device, which is disclosed in Japanese Patent Application laid-open No. Hei 5-313657, informs the user of the difference between the target pitch and the actual pitch of a tone through a lighting pattern on an array of light emitting diodes.

In detail, a row of plural light emitting diodes is provided on the prior art tuning device, and the plural light emitting diodes are selectively energized depending upon the phrase difference between the audio signal representative of the tone produced through a musical instrument and a reference signal representative of the target pitch. A counter is prepared for the reference signal, and switching transistors are connected between the anodes of the light emitting diodes and a power source. A low pass filter is further prepared for the audio signal, and a common switching transistor is connected between the cathodes of the light emitting diodes and the ground.

The counter is incremented by the reference signal, and the plural bits of an output signal are supplied in parallel from the counter to the control nodes of the switching transistors. The output signal of the counter causes the switching transistors sequentially to turn on. Thus, the light emitting diodes sequentially get ready for emitting the light depending upon the frequency of the reference signal. On the other hand, the low-pass filter eliminates high-frequency noise components from the audio signal, and the audio signal causes the common switching transistor to turn on depending upon the fundamental frequency of the audio signal. As a result, a current path is established between the power source and the ground only when the reference signal and audio signal concurrently change the common switching transistor and the switching transistor associated with each light emitting diode to the on-state. Thus, the light emitting diodes are selectively turns on and off so as to form a light pattern on the array of light emitting diodes.

If the audio signal is equal in frequency to the reference signal, all the light emitting diodes regularly turn on, and the light pattern is seemed to stay on the array of light emitting diodes. On the other hand, if the audio signal is different in frequency from the reference signal, the light emitting diodes irregularly turn on and off, and the light pattern is seemed to move on the array of light emitting diodes. Thus, the prior art tuning device notifies the user of the frequency difference through the movement of the light pattern.

While the frequency difference is being relatively small, the light pattern is moved at speed proportional to the amount of frequency difference, and the direction of the movement is depending upon the plus or minus of the difference. However, there is a certain limit on the second prior art tuning device. When the frequency difference exceeds the certain limit such as 20-30 cents, the light pattern is moved very fast, and the worker feels it difficult to determine the direction of movement.

### SUMMARY OF THE INVENTION

It is therefore an important object of the present invention to provide a tuning device, which notifies a user whether the actual frequency of a tone is higher than or lower than the target pitch regardless of the amount of frequency difference together with existence of the frequency difference.

It is also an important object of the present invention to provide a computer program, which is installed in the tuning device.

To accomplish the object, the present invention proposes to analyze an audio signal for existence of pitch difference and a direction of deviation from a target pitch.

In accordance with one aspect of the present invention, there is provided a tuning device for assisting a worker in a tuning work on a musical instrument, comprising a converter converting vibrations representative of a tone produced in the musical instrument to an electric signal representative of the vibrations, an inspector connected to the converter and comparing an actual pitch of the tone expressed by the electric signal with a target pitch of the tone to see whether or not the tone was produced at the target pitch for producing an answer, a visual interface producing a first image expressing whether or not deviation exists between the actual pitch and the target pitch and a second image expressing whether the actual pitch is higher than or lower than the target pitch, a first image producer connected to the inspector and the visual interface and producing the first image in the visual interface on the basis of one of the answer, and a second image producer connected to the inspector and the visual interface and producing the second image in the visual interface separately from the first image on the basis of another of the answer.

In accordance with another aspect of the present invention, there is provided a computer program for assisting a worker in a tuning work on a musical instrument, comprising the steps of a) converting vibrations representative of a tone produced in the musical instrument to an electric signal representative of the vibrations, b) comparing an actual pitch of the tone expressed by the electric signal with a target pitch of the tone to see whether or not the tone was produced at the target pitch for producing an answer, and c) producing a first image expressing whether or not deviation exists between the actual pitch and the target pitch and a second image expressing whether the actual pitch is higher than or lower than the target pitch in a visual interface separately from the first image on the basis of the answers at step b).

### BRIEF DESCRIPTION OF THE DRAWINGS

The features and advantages of the tuning device and computer program will be more clearly understood from the following description taken in conjunction with the accompanying drawings, in which

FIG. 1 is a schematic perspective view showing the external appearance of a tuning device according to the present invention,

FIG. 2 is a front view showing visual images on a display window provided on the tuning device,

FIG. 3 is a block diagram showing the system configuration of a data processing system incorporated in the tuning device,

FIG. 4 is a graph showing relation between the waveform of audio signals and corresponding polarity patterns,

FIG. 5 is a view showing polarity patterns varied with time,

FIG. 6 is a flowchart showing a job sequence expressed by a part of a main routine program,

FIG. 7 is a flowchart showing a job sequence expressed by a subroutine program for existence of pitch difference,

FIG. 8 is a view showing a bit string for the visual images,

FIG. 9 is a flowchart showing a job sequence expressed by a subroutine program for a direction of deviation,

FIGS. 10A and 10B are front views showing another tuning device of the present invention, and

FIG. 11 is a view showing a method for visualizing phrase difference carried out in the tuning device.

### DESCRIPTION OF THE PREFERRED EMBODIMENTS

A tuning device embodying the present invention assists a worker in a tuning work on a musical instrument, and comprises a converter, an inspector, a visual interface, a first image producer and a second image producer. The converter is connected to the inspector, which in turn is connected to the first image producer and second image producer. The first and second image producers are further connected to the visual interface.

The converter receives a tone, which is produced in and propagated from the musical instrument, and converts sound waves or vibrations of the tone to an electric signal. The electric signal is representative of the vibrations of the tone, and is supplied from the converter to the inspector.

In this instance, the inspector is implemented by a part of a computer program running on a data processing system. The inspector determines an actual pitch of the tone on the basis of the vibrations represented by the electric signal, and compares the actual pitch with a target pitch, at which the musical instrument is expected to produce the tone, to see whether or not the tone was produced at the target pitch for producing an answer. The answer is supplied from the inspector to the first image producer and second image producer.

The first image producer analyzes the answer to see whether or deviation exists between the actual pitch and the target pitch, and produces a first image, which expresses whether or not deviation exists between the actual pitch and the target pitch on the visual interface. On the other hand, the second image producer analyzes the answer to see whether the actual pitch is higher than or lower than the target pitch, and produces a second image, which expresses whether the actual pitch is higher than or lower than the target pitch, on the visual interface separately from the first image.

The worker acquires pieces of status information expressing current tuning status of the musical instrument from the first and second images. When the first image is indicative of that any deviation does not exists between the actual pitch and the target pitch, the worker takes the next step in the tuning work. On the other hand, when the first image is indicative of the existence of the deviation, the worker quickly tunes the musical instrument at the target pitch, because the second image teaches the worker the direction of deviation, i.e., either higher or lower. Thus, the tuning device embodying the present invention assists the worker in the tuning work.

### First Embodiment

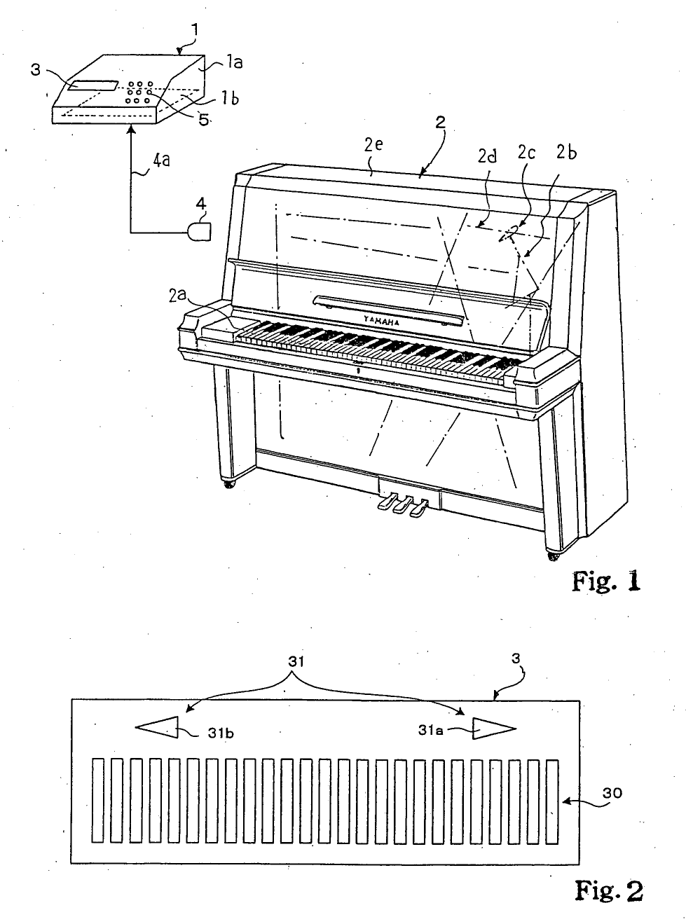

Referring to FIG. 1 of the drawings, a tuning device 1 embodying the present invention largely is used in a tuning work on an upright piano 2. As well-known to persons skilled in the art, the upright piano 2 comprises a keyboard 2a, action units 2b, hammers 2c, strings 2d and a piano cabinet 2e. The keyboard 2a is mounted on a key bed of the piano cabinet 2e, and is exposed to a player who is ready to play a tune thereon. The other component parts, i.e., the action units 2b, hammers 2c and strings 2d are housed in the piano cabinet 2e, and are linked with one another for producing tones. When a pianist depresses one of the black and white keys of the keyboard 2a, the depressed key actuates the action unit 2b, and the action unit 2b drives the hammer 2c for rotation toward the string 2d. The hammer 2c is brought into collision with the string 2d at the end of the rotation, and gives rise to vibrations of the string 2d. The vibrating string 2d in turn gives rise to sound waves, and the sound waves are propagated from the vibrating string 2d through the air. Thus, the tone is produced in the upright piano 2.

The strings 2d are tuned to produce the tones at the predetermined pitches. In other words, pitch names are respectively given to the tones produced through the vibrations of the strings 2d. When the standard pitch is given to a worker, the worker can tune the upright piano, and the strings 2d are adjusted to target values of the pitch at the pitch names, respectively. The upright piano 2 tends to be out of the tune due to aged-deterioration, and the actual values of pitch are deviated from the target values. The upright piano 2 is to be retuned. A worker tunes the upright piano 2 with the assistance of the tuning device 1.

The tuning device 1 comprises a case 1a, a data processing system 1b, a display window 3, a microphone 4 and an array 5 of switches and keys. The data processing system 1b is provided inside of the case 1a, and the microphone 4 is connected to the data processing system 1b through a cable 4a. The display window 3 and array 5 of switches and keys are provided on the case 1a, and are exposed to the worker as a man-machine interface.

A worker is assumed to instruct the tuning device 2 to check the sound waves to see whether or not the upright piano 2 produces the tone at the target pitch. The worker depresses the black/white key assigned the pitch name same as that assigned to the string 2d to vibrate. The string 2d is struck with the hammer 2c, and the sound waves are propagated from the vibrating string 2d to the microphone 4. The sound waves are converted to an analog audio signal in the microphone 4, and the analog audio signal is in turn converted to a series of audio data codes, i.e., a digital audio signal in the data processing system 1b.

The data processing system 1b analyzes the series of audio data codes for the actual pitch of the tone, and determines at least two features of the tuning status. One of the two features of the tuning status relates to whether or not the actual pitch is consistent or inconsistent with the target pitch, and is referred to “existence of pitch difference”. The other feature relates to whether the actual pitch is higher than or lower than the target pitch, and is referred to as “direction of deviation from a target pitch”. When the data processing system 1b determines the two features of the tuning status, the data processing system 1b visualizes the two features in the display window 3, and notifies the worker of the two features through the visual images in the display window 3 so as to assist the worker in the tuning work.

FIG. 2 shows the display window 3. An array of light emitting bars 30 and a pair of directional indicators 31 are provided in the display window 3. In this instance, the light emitting bars 30 are formed from light emitting diodes, and the light emitting diodes cause the light emitting bars 30 selectively to brighten up. The pair of directional indicators 31 includes light emitting triangles 31a and 31b, and light emitting diodes makes the light emitting triangles 31a and 31b selectively brighten up.

The existence of pitch difference is exhibited by means of the array of light emitting bars 30. When a tone produced in the upright piano 2 is consistent in pitch with the tone to be produced, selected ones of the light emitting bars 30 are lightened at all times, and a light pattern is stationary on the array of light emitting bars 30. The light pattern on the array of light emitting bars 30 is one of the visual images for expressing the existence of pitch difference. If, on the other hand, a tone produced in the upright piano 2 is inconsistent in pitch with the tone to be produced, the bright light emitting bars 30 are changed from a cycle time to the next cycle time, and the light pattern is moved on the array of light emitting bars 30. Thus, the tuning device notifies a worker of the existence of pitch difference through the visual image stationary or moving on the array of light emitting bars 30.

The pair of directional indicators 31 is provided in order to exhibit whether the actual pitch is higher than or lower than the target pitch. One of the light emitting triangles 31a/31b is assigned to the deviation toward a higher pitch register, and the other of the light emitting triangles 31a/31b is assigned to the deviation toward a lower pitch register. In this instance, the manufacturer made the light emitting triangles 31a/31b corresponding to the directions of deviation, and the light emitting triangles 31a/31b are respectively labeled with word “high” and “low”. The data processing system 1b makes the decision on the direction of deviation from the target pitch, and makes one of the light emitting triangles 31a/31b brighten up. The bright light emitting triangle and dark light emitting triangle 31a/31b form a visual image expressing the direction of deviation from the target pitch.

The light emitting directional indicators 31 is desirable, because the worker is exactly notified of the direction of deviation regardless of the speed of moving light pattern on the array of light emitting bars 30.

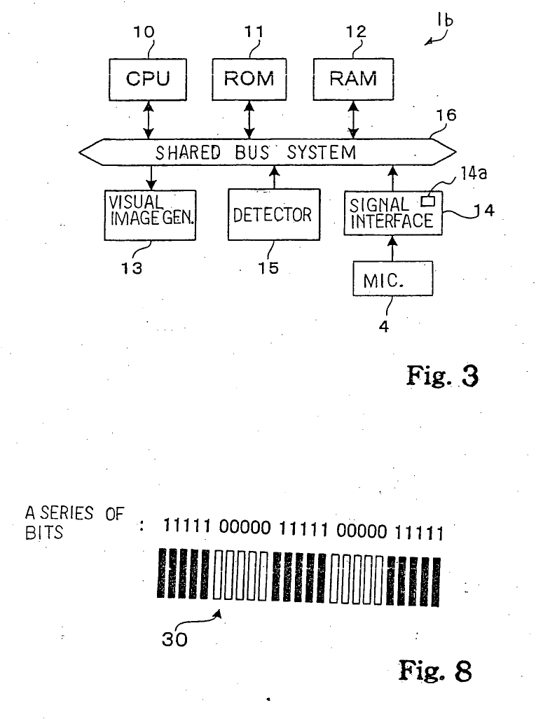

Tuning to FIG. 3 of the drawings, the data processing system 1b includes a central processing unit 10, which is abbreviated as “CPU”, a read only memory 11, which is abbreviated as “ROM”, a random access memory 12, which is abbreviated as “RAM”, a visual image generator 13, a signal interface 14, a detector 15 for switching action and a shared bus system 16. The central processing unit 10, read only memory 11, random access memory 12, visual image generator 13, signal interface 14 and detector 15 are connected to the shared bus system 16 so that the central processing unit 10 is communicable with those system components 11, 12, 13, 14 and 15. The central processing unit 10, read only memory 11, random access memory 12 and a part of the shared bus system 16 may be integrated on a monolithic semiconductor chip as a microcomputer.

A computer program is stored in the read only memory 11, and the instruction codes, which form the computer program, are sequentially read out from the read only memory 11 to the shared bus system 16. The instruction codes thus read out onto the shared bus system 16 are fetched by the central processing unit 10, and are executed for accomplishing a given task. The computer program includes a main routine program and subroutine programs.

The central processing unit 10 is an origin of the data processing capability of the tuning device 1, and achieves jobs through the execution of the instruction codes. When a user supplies electric power to the data processing system 1b, the main routine program starts to run on the central processing unit 10. The central processing unit 10 firstly initializes the data processing system 1b, and waits for a user's instruction through the array of switches/keys 5. A part of the main routine program will be hereinlater described.

One of the subroutine programs is assigned to visualization of the pitch difference between a tone produced in the upright piano 2 and the tone to be produced. When a worker instructs the data processing system 1b to assist him or her in the tuning work on the upright piano 2, the main routine program starts to run on the central processing unit 10 to determine a target pitch given through the array of switches/keys 5, and periodically branches to the subroutine program for the visualization of the pitch difference. Another of the subroutine programs is assigned to visualization of the direction of deviation, and the main routine program also periodically branches to the subroutine program for the direction of deviation. Yet another subroutine program is assigned to estimation of the pitch name of a tone produced in the upright piano 2. When a worker directs the microphone 4 to the upright piano 2 without the data input of any pitch name, the main routine program periodically branches to the subroutine program for the estimation of the pitch name, and visualizes the pitch difference and the direction of deviation through the execution of the above-described subroutine programs. In this instance, the portable tuning device 1 estimates the actual pitch through an autocorrelation. The autocorrelation makes it possible to estimate the periodicity of an input periodic signal.

The random access memory 12 offers a working area to the central processing unit 10. A digital audio signal or a series of audio data codes is accumulated in the random access memory 12 in the tuning work, and the central processing unit 10 examines the series of audio data codes to see how many frequencies the analog audio signal is assumed to have, whether or not a tone, which is expressed by the series of audio data codes, has an actual pitch equal to a target pitch and which direction the actual pitch is deviated from the target pitch.

The signal interface 14 is provided with an analog-to-digital converter 14a. The analog-to-digital converter 14a is connected to the microphone 4 through the cable 4a. An analog audio signal is supplied from the microphone 4 to the analog-to-digital converter 14a, and the analog-to-digital converter 14a samples discrete values on the analog audio signal so as to convert the discrete values to a series of audio data codes. The central processing unit 10 periodically fetches the audio data codes from the signal interface 14, and accumulates the audio data codes in the random access memory 12.

The visual image generator 13 includes a resistor and plural current driver circuits, which are connected in parallel to a power source, and the light emitting diodes of the light emitting bars 30 and light emitting triangles 31a/31b are connected in series to the current driver circuits, respectively. The plural current driver circuits may be implemented by switching transistors with large current driving capability. The resistor has parallel output nodes, and the parallel output nodes are respectively connected to the control nodes of the plural current driving circuits. A multi-bit image signal is supplied from the central processing unit 10 to the resistor, and the resistor changes selected ones of the parallel output nodes to an active level. Then, the plural current driving circuits are selectively turned on and off. The power voltage is supplied through the current driving circuits in the on-state to the associated light emitting diodes, and the light emitting diodes, which are selectively energized with the power voltage, produces the visual image of pitch difference on the array of light emitting bars 30 and the visual image of direction of deviation on the pair of directional indicators 31.

The detector 15 periodically scans the array of switches/keys 5, and informs the central processing unit 10 of the current state of the switches and keys 5.

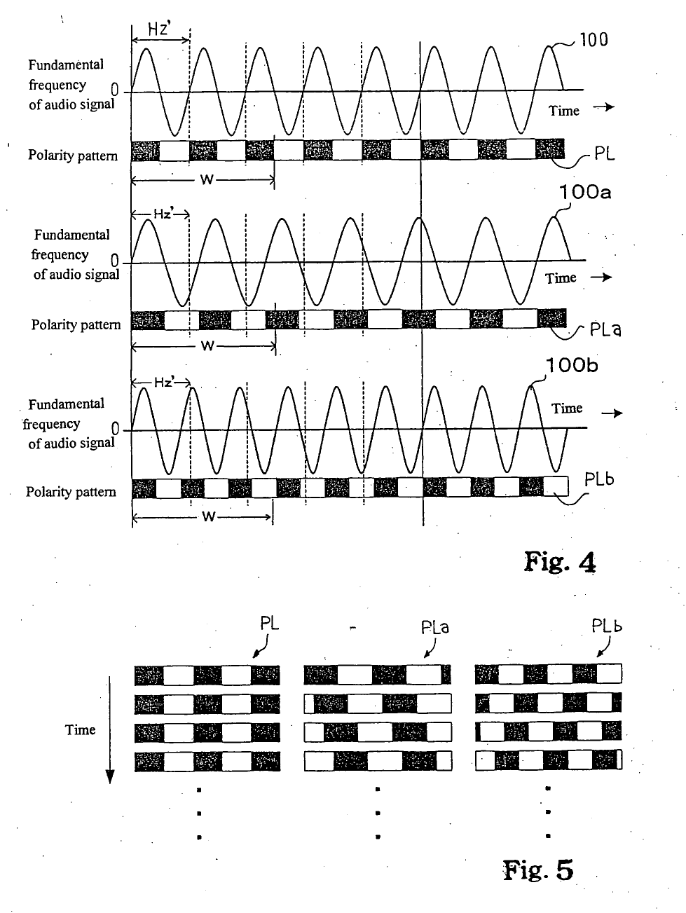

Turning to FIG. 4, description is made on how the existence of pitch difference is visualized. In the following description, term “a piece of polarity data” expresses either positive or negative of a piece of audio data, and term “polarity pattern” is defined as variation in polarity of a series of pieces of polarity data. While the potential level of the audio signal remains positive, the associated pieces of polarity data are expressed as a black section. On the other hand, while the audio signal is being varied in the negative region, the associated pieces of polarity data are expressed as a white section. Term “cycle time” is a time period for keeping a polarity pattern on the array of light emitting bars 30, and the polarity pattern is renewed upon expiry of each cycle time. Term “window W” is defined as a time period over which pieces of audio data are extracted from the accumulated audio data, and is equal to a multiple of the repetition period Hz′ of a target value of the fundamental frequency of an audio signal. The window W is shorter than the cycle time. In this instance, the window W is two and half times longer than the repetition period Hz′.

Assuming now that a waveform 100 expresses a fundamental frequency of an audio signal representative of a tone equal to that of a target pitch of the tone, a waveform 100a expresses a fundamental frequency of an audio signal representative of a tone lower in pitch than the tone expressed by the waveform 100, and a waveform 100b expresses a fundamental frequency of an audio signal representative of a tone higher in pitch than the tone expressed by the waveform 100. The waveforms 100, 100a and 100b repeatedly swing the potential level across zero. The audio signals, which are expressed by the waveforms 100, 100a and 100b, are also labeled with 100, 100a and 100b in the following description.

While the audio signal 100 is being supplied from the microphone 4 to the signal interface 14, the analog-to-digital converter 14a converts the audio signal to audio data codes or pieces of audio data, and the central processing unit 10 accumulates the pieces of audio data in the random access memory 12. The polarity pattern PL expresses the accumulated pieces of audio data. On the other hand, the audio signals 100a and 100b are expressed by the polarity patterns PLa and PLb, respectively.

Plural series of polarity data are extracted from the series of polarity data expressing the polarity pattern PL/PLa/PLb for the window in plural cycle times. In case where the tone has an actual pitch consistent with the target pitch, each of the plural series of polarity data consists of three complete black sections and two complete white sections. The plural series of polarity data are supplied to the visual image generator 13 for the cycle times. Then, the complete three black sections and complete two white sections repeatedly take place on the array of light emitting bars 30, and the light pattern is seen as if it is stationary on the array of light emitting bars 30 as indicated by PL in FIG. 5.

On the other hand, in case where plural series of polarity data are extracted from the series of polarity data expressing the polarity pattern PLa, each of the plural series of polarity data has at least one incomplete black section or incomplete white section so that the light pattern is varied from a cycle time to the next cycle time as indicated by PLa in FIG. 5, and the light pattern is seen as if it moves laterally on the array of light emitting bars 30. In case where the polarity data expressing the polarity pattern PLb is processed as similar to those expressing the polarity patterns PL and PLa, the light pattern is also seen as if it moves laterally on the array of light emitting bars 30.

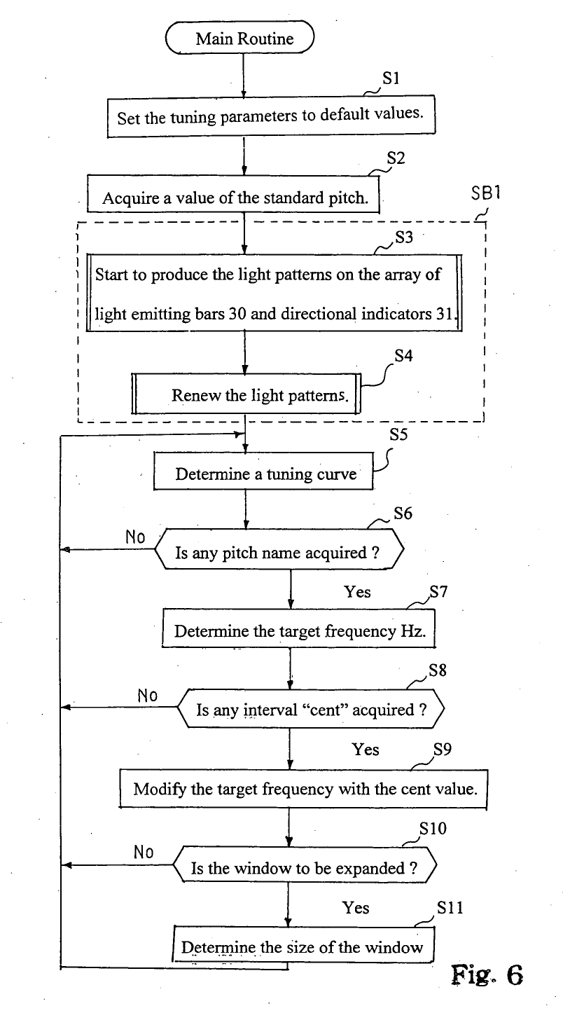

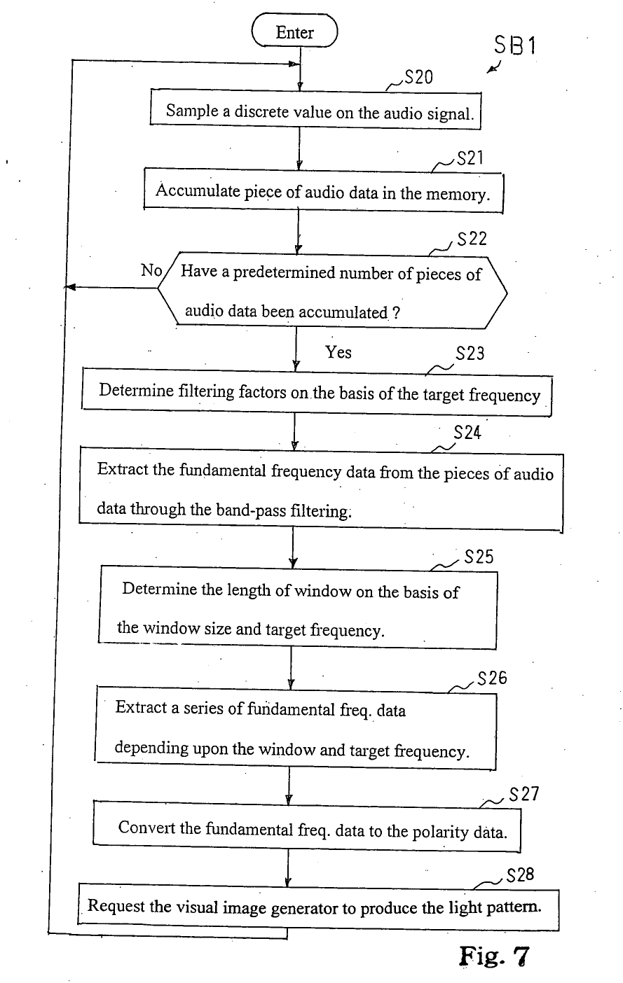

Description is hereinafter made on the computer program. FIG. 6 shows a part of the main routine program relating to the tuning work on the upright piano 2. One of the subroutine programs SB1 is assigned to the visualization of pitch difference, i.e., the production of the light pattern, and is illustrated in FIG. 7. The main routine program and subroutine program SB1 are hereinafter described in detail.

The main routine program periodically branches to the subroutine program SB1, and the central processing unit 10 repeatedly produces the light pattern at regular intervals equal to the cycle time. Although the subroutine program SB1 is inserted between step 2 and step 5 of the main routine program, the main routine program branches to the subroutine program SB1 at every timer interruption regardless of the present job in the main routine program.

A worker is assumed to turn on the power switch of the portable tuning device 1. The central processing unit 10 initializes the data processing system 1b, and sets tuning parameters to default values as by step S10. In this instance, an interval in cent, i.e., a cent value and a window size are the tuning parameters to be set to the default values at step S10.

Subsequently, another tuning parameter, i.e., a standard pitch is determined as by step S2. The standard pitch is a frequency at A to which all the musical instrument and singers participating in an ensemble are to be tuned. There have been proposed several values for the standard pitch such as 440 hertz, 442 hertz, 439 hertz and so forth. In this instance, the default value of standard pitch is 440 hertz. If the worker inputs a value of standard pitch to the tuning device, the standard pitch is set to the given value. Otherwise, the standard pitch is set to a default value. The default values are zero cent for the interval, 2.5 times for the window size and 440 hertz for the standard pitch. are the default values of the interval and window size W. A default tuning curve is further transferred from the read only memory 11 to the random access memory 12. The tuning curve will be described in conjunction with jobs at step S5.

Upon completion of jobs at step S2, the tuning device gets ready to visualize the existence of pitch difference and the direction of deviation, and periodically enters the subroutine program SB1. The central processing unit 10 produces the light patterns on the array of light emitting bars 30 and pair of directional indicators 31 as by step S3, and renews the light patterns as by step S4.

Subsequently, the central processing unit 10 prompts the worker to select a tuning curve as by step S5. The term “tuning curve” means plots indicative of relation between pitch name and target frequency Hz. Plural tuning curves are stored in the read only memory 11 in the form of table. The plural tuning curves or tables express preferable relation between the pitch name and the target frequency for different types of piano such as, for example, the grand piano and upright piano. Different tuning curves may be respectively assigned to plural models of the grand piano/upright piano. This is because of the fact that musicians feel tones in the higher register natural at certain values of frequency higher than the standard values of frequency in the temperament. The certain values are varied depending upon the type and model of piano. For this reason, the plural tuning curves are prepared for pianos. One of the tuning curves serves as the default tuning curve so that the default tuning curve is employed for the tuning work under the condition that the user does not select another tuning curve at step S5. When the worker selects one of the tuning curves, the central processing unit 10 acknowledges the tuning curve selected by the user, and the selected tuning curve is transferred from the read only memory 11 to the random access memory 12 so that the default tuning curve is replaced with the selected tuning curve.

Subsequently, the central processing unit 10 prompts the worker to input a pitch name, and waits for a time. When the worker specifies a pitch name, the answer at step S5 is given positive “Yes”, and the central processing unit 10 checks the tuning curve for the target frequency Hz of a tone to be produced in the upright piano 2 as by step S7. If the time period is expired, the answer at step S6 is given negative “No”. In this situation, if a tone is produced in the upright piano 2, the main routine program starts to branch the subroutine program for the autocorrelation, and determines the pitch name through the execution of the subroutine program.

Subsequently, the central processing unit 10 prompts the worker to input the interval in cent, i.e., cent value, and waits for a time to see whether or not the user inputs the interval as by step S8. When the user inputs the interval in cent, the answer at step S8 is given affirmative “Yes”, and the central processing unit 10 shifts the target frequency Hz from the value on the turning curve by the given cent value as by step S9. If, on the other hand, the predetermined time period is expired without any data input, the answer at step S8 is given negative “No”, and the central processing unit 10 keeps the target frequency Hz determined at step S7.

Subsequently, the central processing unit 10 determines whether or not the worker changes the window size W as by step S10. The central processing unit 10 prompts the worker to input a window size different from the default window size. When the worker input a new window size, the answer at step S10 is given positive “Yes”, and changes the window from the default size to the new size as by step S11. If the time period is expired without any data input, the answer at step S10 is given negative “No”.

With the negative answer at step S6, S8 or S10, the central processing unit 10 returns to step S5. Thus, the central processing unit 10 reiterates the loop consisting of steps S5 to S11, and changes the tuning parameters for the subroutine programs for the visualization, if required.

The subroutine program SB1 is described in detail with reference to FIG. 7. The main routine program is assumed to branch to the subroutine program SB1. While the microphone 4 is supplying the audio signal to the signal interface 14, the analog-to-digital converter 14a periodically samples discrete values on the audio signal, and the discrete value is fetched by the central processing unit 10 as by step S20. The central processing unit 10 transfers a piece of audio data, which expresses the discrete value, to the random access memory 12 so as to accumulate the piece of audio data in the random access memory 12 as by step S21.

The central processing unit 10 checks the random access memory 12 to see whether or not a predetermined number of pieces of audio data are found in the random access memory 12 as by step S22. In this instance, the predetermined number is fallen within the range between 1024 and 2048. While the pieces of audio data are being increased toward the predetermined number, the answer at step S22 is given negative “No”, and the central processing unit 10 repeatedly returns to step S20. Thus, the central processing unit 10 reiterates the loop consisting of steps S20 to S22 so as to increase the pieces of audio data accumulated in the random access memory 12.

When the pieces of audio data reach the predetermined number, the answer at step S22 is changed to affirmative “Yes”. With the positive answer “Yes”, the central processing unit 10 determines filtering factors on the basis of the modified target frequency Hz as by step S23. The filtering factors define the filtering characteristics of a band-pass filter. The bandwidth and center frequency serve as the filtering factors.

Subsequently, the band-pass filtering is carried out on the pieces of audio data so that the fundamental frequency component, which is expressed by pieces of fundamental frequency data, is extracted from the pieces of audio data as by step S24. In other words, the harmonics and noise are eliminated from the pieces of audio data. The pieces of fundamental frequency data are stored in the random access memory 12.

Subsequently, the central processing unit 10 reads out the size of window W from the random access memory 12, and calculates the length of window. As described hereinbefore, the user has inputted the ordinary size, i.e., 2.5 times. The central processing unit 10 reads out the target frequency Hz and the size W from the random access memory 12. The central processing unit 10 determines the inverse Hz′ of the target frequency Hz, and multiplies the inverse Hz′ by 2.5. Thus, the central processing unit 10 sets the window to (Hz′×2.5) as by step S25.

Subsequently, the central processing unit 10 extracts a series of fundamental frequency data from the pieces of fundamental frequency data already stored in the random access memory 12 for the renewal time period as by step S26. The series of fundamental frequency data is adapted to occupy the window. In other words, the length of window is equal to the product between the number of pieces of fundamental frequency data and the sampling period.

Subsequently, the series of fundamental frequency data is converted to a series of polarity data as by step S27. As described hereinbefore, if certain pieces of fundamental frequency data have positive numbers, the certain pieces of fundamental frequency data are replaced with pieces of polarity data expressing binary number “1”. On the other hand, if pieces of fundamental frequency data have negative numbers, the pieces of fundamental frequency data are replaced with pieces of polarity data expressing binary number “0”. As a result, a bit string is left in the random access memory 12. The bit string forms an essential part of the multi-bit image signal.

The bit string expresses the light pattern on the array of light emitting bars 30. FIG. 8 shows an example of a bit string and the corresponding light pattern on the array of light emitting bars 30. In this instance, twenty-five light emitting diodes form the light emitting bars 30, and twenty-five bits are the essential part of the multi-bit image signal.

The central processing unit 10 transfers the multi-bit image signal to the visual image generator 13, and requests the visual image generator 13, to produce the light pattern on the array of light emitting bars 30 as by step S28. The twenty-five bits make the current driving circuits selectively turn on and off so that the power voltage is applied to the light emitting diodes through the current driving circuits in the on-state. Thus, the light pattern takes place on the array of light emitting bars 30.

The central processing unit 10 repeats the jobs at steps S20 to S28 so that the light pattern is periodically renewed. If the audio signal expresses the target pitch of tone, the worker sees the light pattern as if it stops on the array of light emitting bars 30 as designated by PL in FIG. 5. If, on the other hand, the actual pitch is different from the target pitch, the worker sees the light pattern as if it flows in the lateral direction as designated by PLa and PLb in FIG. 5. Thus, the worker confirms the existence of pitch difference through the movement of the light pattern.

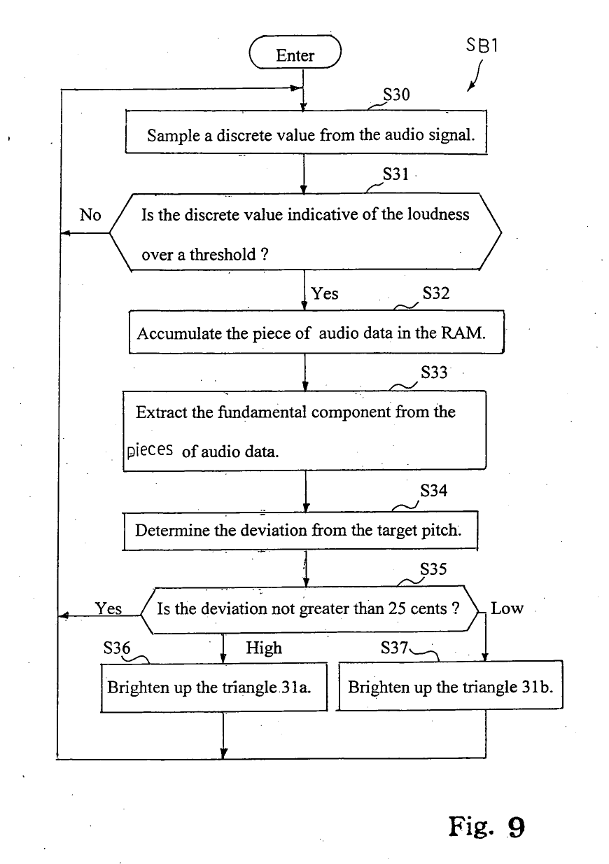

FIG. 9 shows a job sequence of the subroutine program for the direction of deviation, and the central processing unit 10 executes the subroutine program shown in FIG. 9 in parallel to the subroutine program shown in FIG. 7 at steps S3 and S4.

When entering the subroutine program for the direction of deviation, the central processing unit 10 requests the signal interface 14 to convert a discrete value on the analog audio signal to the audio data code or the piece of audio data as by step S30.

Subsequently, the central processing unit 10 checks the piece of audio data to see whether or not the tone is produced at loudness larger than a threshold as by step S31. When the microphone 4 picks up noise in the environment, the environmental sound is usually faint, and the answer at step S31 is given negative “No”. Then, the central processing unit 10 discards the piece of audio data, and returns to step S30.

On the other hand, when the tone is produced in the upright piano 2, the tone is loud, and the answer at step S31 is given affirmative “Yes”. With the positive answer, the central processing unit 10 transfers the piece of audio data to the random access memory 12, and stores it therein as by step S32. Though not shown in FIG. 9, the central processing unit 10 repeats the steps. S30 to S32 until a predetermined number of pieces of audio data are found in the random access memory 12.

Subsequently, the central processing unit 10 extract the fundamental component from the pieces of audio data already accumulated in the random access memory 12 as by step S33. The actual frequency is determined on the basis of the fundamental component. The time intervals between the zero-crossing points may be calculated for the actual frequency, or the actual frequency may be determined through the autocorrelation analysis disclosed in Japanese Patent Publication No. Hei 3-42412, which was hereinbefore described as the prior art. When the actual frequency is determined, the central processing unit 10 reads out the target frequency Hz from the random access memory 12, and calculates the deviation of actual frequency from the target frequency Hz as by step S34.

Subsequently, the central processing unit 10 subtracts the amount of deviation from 25 cents to see whether or not the absolute value of deviation is not greater than 25 cents and whether the difference is a negative quantity or a positive quantity as by step S35. When the amount of deviation is equal to or less than 25 cents, the central processing unit 10 returns to step S30 without producing the light pattern on the pair of directional indicators 31. This is because of the fact that the worker can determine the direction of deviation through the movement of light pattern in so far as the amount of deviation is relatively small. Although the critical amount is dependent on workers, the criterion ranges from 20 cents to 30 cents. If the amount of deviation is greater than 25 cents, the central processing unit 10 proceeds to either step S36 or step S37. In case where the deviation has a positive quantity, the answer at step S35 is given “High”, and the central processing unit 10 supplies the multi-bit image code to the visual image generator 13. With the multi-bit image code, the visual image generator 13 makes the light emitting triangles 31a and 31b bright and dark, respectively, as by step S36. In case where the deviation has a negative quantity, the answer at step S35 is given “Low”, and the central processing unit 10 causes the visual image generator 13 to make the light emitting triangles 31a and 31b dark and bright, respectively, at step S37. Although the multi-bit image code is produced only for the light emitting triangles 31a and 31b, the multi-bit image code includes the data bits for the array of light emitting bars 30. In other words, the array of light emitting bars 30 and pair of directional indicators 31 are concurrently controlled with the multi-bit image code.

Upon completion of the jobs at step S36 or S37, the central processing unit 10 returns to step S30. Thus, the central processing unit 10 periodically reiterates the loop consisting of steps S30 to S37 for producing the light pattern on the pair of directional indicators 31.

As will be understood from the foregoing description, the tuning device 1 informs the worker of the existence of pitch difference and the direction of deviation through the visual images in the display window. The worker accurately tunes the upright piano 2 with the assistance of the tuning device 2.

### Second Embodiment

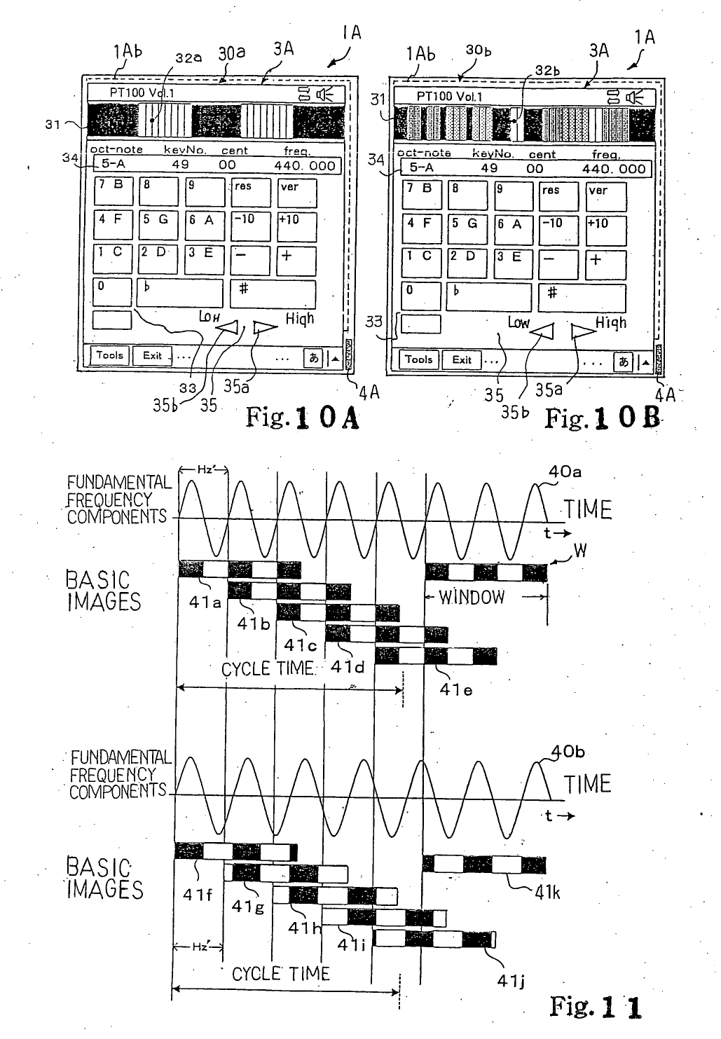

Turning to FIGS. 10A and 10B, another tuning device 1A embodying the present invention comprises a data processing system 1Ab, a touch-panel liquid crystal display device 3A and a built-in microphone 4A. The data processing system 1Ab is similar in system configuration, and the display window 3 and array of switches and keys 5 are replaced with the touch-panel liquid crystal display device 3A. Although the visual image generator 13 and detector 15 are replaced with a graphic controller and a touch-panel controller, the other features of the data processing system 1Ab is similar to those of the data processing system 1b so that description on the system components is omitted for the sake of simplicity.

The graphic controller produces a picture 30a or 30b on the touch-panel display device. The picture 30a or 30b has at least four areas 31, 33, 34 and 35. The area 31 is assigned to a gradation image 32a or 32b. A target waveform is representative of a target pitch or target frequency to which the musical instrument is to be tuned, and an actual waveform is found on the analog audio signal. In case where the actual waveform of the analog audio signal has a repetition period equal to that of the target waveform, a two-tone gradation pattern 32a is stable in the area 31, and the user finds the gradation image 32a not to be moved in the area 31. On the other hand, if the difference takes place between the actual waveform and the target waveform, the user finds a more-than-two-tone gradation image 32b to be moved in the lateral direction of the area 31.

The areas 33 and 35 are assigned to images of button switches. “7B”, “8”, “9”, “res”, “ver”, “4F”, “5G”, “6A”, “−10”, “+10”, “1C”, “2D”, “3E”, “−”, “+”, “0”, “b” and “#” are enclosed with rectangles, which express the peripheries of the button switches. The button switches “7B”, “4F”, “5G”, “6A”, “1C”, “2D” and “3E” are shared between the numerals “7”, “4”, “5”, “6”, “1”, “2” and “3” and the alphabets “B”, “F”, “G”, “A”, “C”, “D” and “E”. The alphabets express pitch names. Users specify a pitch name and an octave by pressing the button switches with a tool. When a user pushes the image of button switch “Tools”, a job list is displayed on the entire area instead of the picture 30a or 30b shown in FIG. 10A or 10B.

The area 34 is assigned to pieces of tuning information. Abbreviations “oct-note”, “keyNo.”, “cent” and “freq” are labeled with four sub-areas in the rectangle produced in the area 34. The visual images below the abbreviation “oct-note” express a pitch name assigned the tone to be targeted and an octave where the tone belongs. The visual image “5-A” means that the tone to be targeted is A in the fifth octave. The central processing unit determines the pitch name and octave through execution of a subroutine program, and informs the user of the pitch name and octave through the visual images in the sub-areas below the abbreviation “oct-note”. The visual image below the abbreviation “keyNo.” expresses the key number assigned the key at “5-A”. An upright piano has eighty-eight black and white keys, and the key numbers “1” to “88” are assigned to the eighty-eight black and white keys. The pitch name A in the fifth octaves is assigned to the key with the key number “49”.

The visual image below the abbreviation “cent” expresses the interval between two tones. As well know to the persons skilled in the art, a whole tone in the temperament is equivalent to 200 cents, and, accordingly, the semitone is equivalent to 100 cents. When a user wishes to specify a tone offset from the tone “5-A” by a quarter tone, he or she inputs “50” cents through the visual images of button switches. When the visual images of “00” is produced in the sub-area below “cent”, the tone is to be found just at A in the fifth octave.

The visual images below the abbreviation “freq.” express the target frequency corresponding to the target pitch to which the musical instrument is to be tuned during data input by a user. A frequency, which is corresponding to the designated pitch name, is to be modified with the interval “cent” for the target pitch “freq.”. Numeral images “440.00” is read in the sub-area under the abbreviation “freq.” together with the pitch name “5-A” and interval “00”. This means that the tone “A” in the fifth octave, which is produced through the musical instrument, is to be found at 440.00 hertz. Though not shown in the drawings, while the tuning device 1A is assisting the user in the tuning work on the upright piano, the tuning device 1A can estimate the target frequency of a tone produced in the upright piano without user's designation, and produces a visual image of the target frequency Hz.

At the beginning of the tuning work, a user may specify a value of the target pitch through the data input for the standard pitch, pitch name, octave and interval through the manipulation on the images of button switches. The portable tuning device can estimate the tone at a corresponding pitch. In case where the portable tuning device determines the pitch name on the basis of the estimated pitch, the user inputs only the standard pitch and interval.

In both cases, the central processing unit causes the graphic controller to produce the visual images expressing the pitch name, octave and interval in cent below the abbreviations “oct-note” and “cent”. The central processing unit determines the key number on the basis of the pitch name and octave, and further determines the fundamental frequency on the basis of the pitch name, octave and interval. The fundamental frequency features the tone assigned the target pitch name, and serves as the target pitch in this instance.

In order quickly to determine the key number and frequency, the pitch names in several octaves, key number assigned to the black and white keys of a standard piano and values of fundamental frequency are correlated with one another for several values of the standard pitch in the read only memory. When a user inputs a value of the standard pitch, a pitch name and an octave through the touch-panel liquid crystal display device 3A, the central processing unit determines the pitch name in the given octave on the basis of the coordinates reported from the touch-panel controller, and accesses a table, which is assigned to the designated standard pitch, in the read only memory with the pitch name in the given octave. Then, the fundamental frequency and key number are read out from the read only memory to the central processing unit. The central processing unit supplies pieces of visual data expressing the pitch name, octave, key number and target frequency to the graphic controller, and the visual images are produced in the area 34 under the control of the graphic controller.

If the user further inputs the interval from the tone assigned the pitch name, the visual image of which is presently produced in the area 34, the touch-panel controller reports the coordinate of the visual image of button switch pushed by the user to the central processing unit, and the central processing unit converts the interval from the cent value to the hertz. The central processing unit adds the interval expressed in hertz to the fundamental frequency, and supplies the pieces of visual data expressing the new fundamental frequency to the graphic controller. The visual image of interval in cent and visual image of new fundamental frequency are produced in the area 34 under the control of the graphic controller.

An image of a pair of directional indicators 35a/35b is produced in the area 35. The image of directional indicator 35a is accompanied with an image of a word “High”, and the graphic controller makes the image of directional indicator 35a brighten up for tones, the actual pitch of which is higher than the target pitch. On the other hand, when tones have the actual pitch lower than the target pitch, the graphic controller makes the other image of directional indicator 35b brighten up.

While the sound waves are being propagated from the upright piano to the portable tuning device 1A, the portable tuning device 1A analyzes the analog audio signal for the difference between the actual pitch and the target pitch, and visualizes the pitch difference on the touch-panel liquid crystal display device 3A and the direction of deviation. Thus, the portable tuning device 1 according to the present invention assists the worker in the tuning work through the visual images of the pitch difference and the visual image of the direction of deviation.

Description is hereinafter made on how the gradation images 32a and 32b are selectively produced on the area 31 with reference to FIG. 11. In the following description, term “cycle time” is defined as a time period for producing the gradation image 32a or 32b, and a worker is assumed to tune an upright piano with the assistance of the tuning device 1A.

Assuming now that a user inputs pitch name of “A” in the fifth octave by selectively pushing the images of button switches in the area 33, the central processing unit determines that the target pitch is 440.00 hertz. The user is assumed not to input the offset or interval from the target pitch. The central processing unit requests the graphic controller to produce the visual images “5-A”, “49”, “00” and “440.00” in the area 34 as shown in FIGS. 10A and 10B.

When the user depresses the key assigned the key number of 49, the piano tone is produced inside the upright piano, and the sound waves, which express the piano tone, are propagated to the built-in microphone 4A. The sound waves are converted to the audio signal by means of the built-in microphone 4A, and the audio signal is transferred to the signal interface.

The audio signal is sampled at regular intervals, which is much shorter than the repetition period or the inverse Hz′ of target frequency, and the fundamental frequency component is extracted from the discrete values on the audio signal. The pieces of fundamental frequency data, which express the fundamental frequency component, are accumulated in the random access memory. The fundamental frequency component is representative of the actual frequency of the fundamental frequency of audio signal, and expresses the waveform labeled with 40a or 40b in FIG. 11.

Plural series of pieces of fundamental frequency data are extracted from the accumulated pieces of fundamental frequency data 40a or 40b. The delay time, which is equal to the inverse Hz′ of target frequency, is introduced between each of the plural series of pieces of fundamental frequency data and the next series of pieces of fundamental frequency data.

The plural series of fundamental frequency data are converted to plural series of polarity data. In this instance, the positive discrete values and negative discrete values are replaced with “1” and “0”, respectively. A bit string “1” expresses the positive portion of the polarity pattern, and is colored in black in FIG. 11. On the other hand, a bit string “0” expresses the negative portion of the polarity pattern, and is colored in white in FIG. 11. The single signal waveform of the fundamental frequency component 40a/40b of audio signal is formed by a pair of positive portion and negative portion so that the pieces of polarity data are expressed as pairs of positive and negative portions.

The window is assumed to be two and half times longer than the inverse Hz′ of target frequency. The central processing unit extracts the plural series of pieces of polarity data for the windows, respectively, and the plural series of pieces of polarity data express the basic images 41a, 41b, 41c, 41d, 41e, . . . or 41f, 41g, 41h, 41i, . . . . The delay time, which is equal to the inverse Hz′ of target frequency, is introduced between the adjacent two series of pieces of polarity data so that basic images 41b, 41c, 41d, 41e, . . . or 41g, 41h, 41i, 41j, . . . are offset from the previous series of polarity data 41a, 41b, 41c, 41d, . . . or 41f, 41g, 41h, 41i by the inverse Hz′ of target frequency.

The fundamental frequency component of audio signal 40a swings the potential level at 440.00 hertz, which is equal to the target frequency, so that each signal waveform is equal in length to the inverse Hz′ of target frequency. The positive portion is equal in length to half of the wavelength of the fundamental frequency component 40a of audio signal, and the negative portion is also equal to the other half of the wavelength of the fundamental frequency component 40a of audio signal. For this reason, the boundary between the positive portion and the negative portion is just aligned with the zero-cross point on the time base. Since the window is two and half times longer than the inverse Hz′ of target frequency, the basic images 41a, 41b, 41c, 41d, 41e, . . . just occupy the windows, respectively. In other words, each of the basic images 41a, 41b, 41c, 41d, 41e, . . . is same as the other basic images 41b, 41c, 41d, 41e . . . , 41a.

On the other hand, the fundamental frequency component 40b of audio signal has the wavelength longer than the inverse Hz′ of target frequency so that each of the polarity patterns in the basic images 41f, 41g, 41h, 41i, 41j . . . becomes longer than the inverse Hz′ of target frequency. The boundary between the positive portion and the negative portion is not aligned with the zero-cross point on the time base, and two and half polarity patterns do not occupy the single window. As a result, the ratio between the positive portion and the negative portion in each window is varied, and the boundary between the positive portion and the negative portion is moved together with time.

The central processing unit compares the bit pattern of the series of pieces of polarity data with that of the other series of pieces of polarity data as if the images 41a, 41b, 41c, 41d, 41e, . . . or 41f, 41g, 41h, 41i, 41j, . . . are superimposed on one another.

When the upright piano produces the sound waves equivalent to the fundamental frequency component 40a of audio signal, the basic images 41a, 41b, 41c, 41d, 41e, . . . have the boundaries between the positive portions and the negative portions aligned with the boundaries of the other basic images 41b, 41c, 41d, 41e, . . . , 41a, and the basic images 41a, 41b, 41c, 41d and 41e are formed into the gradation image 32a as shown in FIG. 10A. Although the graphic controller repeatedly produces the gradation image 32a in the area 32a at the renewal timing under the control of the central processing unit, the gradation image 32a is same as that in the previous cycle times. The worker finds the two-tone gradation image 32a stationary in the area 31. Thus, the portable tuning device informs the user that the upright piano has been correctly tuned at the key number 49.

On the other hand, if the upright piano produces the sound waves equivalent to the fundamental frequency component 40b of audio signal, the fundamental frequency component 40b of audio signal has the signal period longer than the inverse Hz′ of target frequency, and, accordingly, the polarity pattern for the fundamental frequency component 40b of audio signal becomes longer than that for the fundamental frequency component 40a of audio signal. The window is also two and half times longer than the inverse Hz′ of target frequency is. As a result, two-odd polarity patterns occupy the window. The delay time is also introduced between the basic images 41f, 41g, 41h, 41i, 41j, . . . and the next basic images 41g, 41h, 41i, 41j, . . . . When the basic images 41f, 41g, 41h, 41i, 41j, . . . are superimposed on one another, the boundaries between the positive portions and the negative portions in the basic images 41g, 41h, 41i, 41j, . . . are offset from the boundaries between the positive portions and the negative portions in the basic images 41f, 41g, 41h, 41i, 41j, . . . by a short time. Parts of all the positive portions are overlapped with one another for producing black sections, and parts of all the negative portions are overlapped with one another for producing white sections. However, other parts of several positive portions are overlapped with parts of the negative positions for producing gray sections. As a result, the basic images 41f, 41g, 41h, 41i and 41j are formed into the gradation image 32b. The gradation image 32b is constituted by more than two tones, and is discriminative from the gradation image 32a.

When the gradation image 32b is renewed, the basic images 41f, 41g, 41h, 41i, 41j are changed to different basic images 41k . . . . Comparing the basic image 41f with the basic image 41k, it is understood that the boundaries between the positive portions and the negative portions are moved from the basic image 41f to the basic image 41k. For this reason, the user feels the more-than-two-tone gradation image 32b laterally moved in the area 31. While the graphic controller is repeatedly producing the gradation image 32b, the user understands the difference from the target pitch through the movement of the gradation image 32b.

The central processing unit subtracts the actual pitch from the target pitch to see whether the difference is a positive quantity or a negative quantity. When the difference is a positive quantity, the central processing unit requests the graphic controller to make the images of directional indicators 35a and 35b bright and dark. On the other hand, if difference is a negative quantity, the central processing unit requests the graphic controller to make the images of directional indicators 35a and 35b dark and bright. Thus, the tuning device 1A notifies the worker of the existence of pitch difference through the more-than-two-tone gradation image 32b laterally moved and the direction of deviation through the images of directional indicators 35a/35b.

As will be understood, the tuning device 1A also assists the worker in tuning work on the piano through the gradation image 32a or 32b and the images of directional indicators 35a/35b so that the worker completes the tuning work within a short time period.

Although particular embodiments of the present invention have been shown and described, it will be apparent to those skilled in the art that various changes and modifications may be made without departing from the spirit and scope of the present invention.

The microphone 4 and cable 4a may be replaced with a built-in microphone provided on the case 1a.

A worker may make the light emitting triangles 31a/31b correspond to the directions of deviation through the array of keys and switches 5. The worker can make the right light emitting triangles 31a and 31b corresponding to the deviation toward the higher pitch register and deviation toward the lower pitch register, respectively, or vice versa.

The array of light emitting bars 30 and pair of directional indicators 31 may be replaced with images of light emitting bars and images of directional indicators 31 on a liquid crystal display panel or the likes.

The steps S1 to S5 may be arranged in an order different from that shown in FIG. 6.

A worker may vary the critical pitch difference, i.e., 25 cents. Otherwise, the tuning device may always cause the light emitting triangle either 31a or 31b to brighten up regardless of the amount of pitch difference.

The tuning device of the present invention is available for another sort of acoustic musical instrument such as, for example, a stringed musical instrument, a window musical instrument and a percussion musical instrument, a hybrid musical instrument and an electronic musical instrument.

The tuning device may be implemented by a wrap-top personal computer system, a PDA (Personal Digital Assistants), a mobile telephone or the likes. The computer program may be stored in a suitable information storage medium such as, for example, a compact disk. Otherwise, uses may download the computer program from a program source through a public communication network.

Claim languages are correlated with the system components and steps in computer program as follows. The upright piano 2 is a “musical instrument”, and the microphone 4 or 4A and signal interface 14 as a whole constitute a “converter”. The data processing system 1b/1Ab and steps S20 to S26 as a whole constitute an “inspector”. The waveforms 100/100a/100b and 40a/40b express an “actual pitch” of tones, and the repetition period or inverse Hz′ of target frequency expresses a “target pitch”. The visual image generator 13 and display window 3 or graphic controller and touch-panel liquid crystal display device 3A as a whole constitute a “visual interface”. The data processing system 1b/1Ab and steps S27 and S28 as a whole constitute a “first image producer”, and the data processing system 1b/1Ab and steps S30 to S37 as a whole constitute a “second image producer”. The bright light emitting bars 30 and dark light emitting bars 30 form a “first image”, and the bright light emitting triangle and dark light emitting triangle 31a/31b form a “second image”.

The array of light emitting bars 30 serve as “light emitting segments”, and the pair of light emitting triangles 31a/31b are corresponding to a “pair of directional indicators”.

What is claimed is:

1. A tuning device for assisting a worker in a tuning work on a musical instrument, comprising:
a converter converting vibrations representative of a tone produced in said musical instrument to an electric signal representative of said vibrations;
an inspector connected to said converter, and comparing an actual pitch of said tone expressed by said electric signal with a target pitch of said tone to see whether or not said tone was produced at said target pitch for producing an answer;
a visual interface producing a first image expressing whether or not deviation exists between said actual pitch and said target pitch and a second image expressing whether said actual pitch is higher than or lower than said target pitch;
a first image producer connected to said inspector and said visual interface, and producing said first image in said visual interface on the basis of said answer; and
a second image producer connected to said inspector and said visual interface, and producing said second image in said visual interface separately from said first image on the basis of said answer.

2. The tuning device as set forth in claim 1, in which said first image is stationary in the absence of said deviation, and moves in said visual interface in the presence of said deviation.

3. The tuning device as set forth in claim 1, in which said first image expressing a large amount of said deviation is moved faster than said first image expressing a small amount of said deviation is.

4. The tuning device as set forth in claim 3, in which said second image is produced when the movement of said first image expresses a certain amount of said deviation or more deviation.

5. The tuning device as set forth in claim 4, in which said certain amount of said deviation ranges from 20 cents to 30 cents.

6. The tuning device as set forth in claim 1, in which said visual interface includes
an array of light emitting segments selectively brightening up and kept dark,
a pair of directional indicators selectively brightening up and kept dark, and
a visual image generator connected to said array of light emitting segments and said pair of directional indicators and supplying electric power to said array of light emitting segments and said pair of directional indicators,
said visual image generator causing selected ones of the light emitting segments of said array to brighten up over plural cycle times in the absence of said deviation,
said visual image generator changing said selected ones of said light emitting segments from a cycle time to the next cycle time in the presence of said deviation,
said visual image generator making one of the directional indicators of said pair brighten up in the presence of said deviation.

7. The tuning device as set forth in claim 6, in which said visual image generator changes said selected ones of said light emitting segments in the presence of a large amount of said deviation more frequently than those in the presence of a small amount of said deviation.

8. The tuning device as set forth in claim 7, in which said visual image generator makes said one of said directional indicators brighten up when the frequency of the change expresses a certain amount of said deviation or more deviation.

9. The tuning device as set forth in claim 8, in which said certain amount of said deviation ranges from 20 cents to 30 cents.

10. The tuning device as set forth in claim 6, in which said array of light emitting segments and said pair of directional indicators include plural light emitting diodes connected to said visual image generator.

11. The tuning device as set forth in claim 1, in which said inspector has plural sets of data blocks expressing tuning curves difference from one another and each defining a relation between pitch names and values of said target pitch, and said worker selects one of said tuning curves so that said inspector determines said target pitch from said pitch name.

12. The tuning device as set forth in claim 11, in which said worker gives said pitch name to said inspector.

13. A computer program for assisting a worker in a tuning work on a musical instrument, comprising the steps of:
a) converting vibrations representative of a tone produced in said musical instrument to an electric signal representative of said vibrations;
b) comparing an actual pitch of said tone expressed by said electric signal with a target pitch of said tone to see whether or not said tone was produced at said target pitch for producing an answer; and
c) producing a first image expressing whether or not deviation exists between said actual pitch and said target pitch and a second image expressing whether said actual pitch is higher than or lower than said target pitch in a visual interface separately from said first image on the basis of said answers at step b).

14. The computer program as set forth in claim 13, in which said step a) includes the sub-steps of
a-1) converting said vibration of said tone to an analog signal, and
a-2) converting discrete values on said analog signal to audio data codes serving as said electric signal.

15. The computer program as set forth in claim 13, in which said step b) includes the sub-steps of
b-1) extracting a fundamental component expressing an actual pitch of said tone from said electric signal, and
b-2) calculating a difference between said actual pitch and said target pitch for determining an absolute value of said deviation and a sign expressing a polarity of said difference.

16. The computer program as set forth in claim 15, in which said target pitch is determined from a pitch name on the basis of a tuning curve selected by said worker.

17. The computer program as set forth in claim 15, in which said fundamental component is extracted from said electric signal through a digital filtering at said step b-1).

18. The computer program as set forth in claim 13, in which said step c) includes the sub-steps of
c-1) producing said first image and said second image at a first area and a second area in said visual interface for a cycle time,
c-2) keeping said first image and said second image at said first area and said second area for the next cycle time in the absence of said deviation, and
c-3) changing said first image from said first area to a third area in said visual interface without any change of said second image from said second area for the next cycle time without any execution of said step c-2) in the presence of said deviation.

19. The computer program as set forth in claim 18, in which said second image is produced at said second area when said deviation has a certain amount or more.

20. The computer program as set forth in claim 19, in which said certain amount ranges from 20 cents to 30 cents.
